(19) United States
(12) Patent Application Publication
(10) Pub. No.: US 2023/0419322 A1
(43) Pub. Date: Dec. 28, 2023

(54) METHOD AND APPARATUS FOR PROCESSING BLOCKCHAIN MESSAGES

(71) Applicant: ELECTRONICS AND TELECOMMUNICATIONS RESEARCH INSTITUTE, Daejeon (KR)

(72) Inventor: Hwanjo HEO, Daejeon (KR)

(21) Appl. No.: 17/953,515

(22) Filed: Sep. 27, 2022

(30) Foreign Application Priority Data
Jun. 28, 2022 (KR) 10-2022-0079132

(51) Int. Cl. G06Q 20/40; G06Q 20/22

(52) U.S. Cl. CPC G06Q 20/401; G06Q 20/223

(57) ABSTRACT

A method for processing blockchain messages in a blockchain node of a blockchain system is provided. The blockchain node receives a transaction delivery message including at least one transaction, checks a reference block height indicating a time point in which the transaction is composed or a time point when the transaction is verified, and verifies validity of the transaction using the reference block height and a current block height.

### CROSS-REFERENCE TO RELATED APPLICATION

This application claims priority to and the benefit of Korean Patent Application No. 10-2022-0079132 filed in the Korean Intellectual Property Office on Jun. 28, 2022, the entire contents of which are incorporated herein by reference.

### BACKGROUND OF THE INVENTION

### 1. Field of the Invention

The present disclosure relates to a method and apparatus for processing blockchain messages, and more particularly, to a method and apparatus for processing blockchain messages that enable secure synchronization even under a high network load.

### 2. Description of Related Art

A blockchain system is widely used today to provide a transaction ledger that is both transparent and immutable. The ledger (e.g., blocks) in a blockchain system are shared by distributed nodes, blocks are issued by consensus, and transactions are invoked by various users.

Transactions are stored in blocks in the blockchain system. Each blockchain system defines transactions differently. A transaction is essentially a transfer of cryptocurrency. A transaction is defined in a blockchain system (e.g., Ethereum) with a smart contract as a task caused by externally owned accounts (EOA) that modify the state stored in the blockchain network. Miners want their mined blocks to be included in the canonical chain so that they can add blocks to the chain by propagating them through the network. Miners are rewarded with cryptocurrency when their blocks are added to the main chain.

Without a centralized server, each node in a blockchain system participates in the blockchain network. In general, blockchain nodes communicate with one another via a peer-to-peer (P2P) network connection. It is difficult to trust a specific node unconditionally in the case of a public blockchain where anyone can participate, and even malicious nodes can participate. As a result, blockchain nodes must always verify and selectively accept information transmitted by connected peer nodes.

As a result, every blockchain node must have at least one benign neighboring node. It is fundamentally impossible to obtain correct information when all neighboring nodes are malicious. Furthermore, there is no way to determine whether the neighboring node to which the connection is being made is without a malicious intention. Even if a node appears to be completely benign based on her behavior, the node may later switch to attacking for some reason. It is advantageous to establish as many connections as possible in order for a blockchain node to have one or more benign neighboring nodes. Accordingly, current blockchain softwares are designed to make many (e.g., more than a hundred) peer connections by default.

More transactions are processed per unit time as the blockchain's performance improves, and as information is received from a large number of neighboring nodes, the message processing load on each blockchain node increases. Such a load can occur instantly and intensely, with a wide range of change depending on network conditions. As a result, it may be difficult for neighboring nodes to always provide sufficient performance to handle the load. As a result, it is critical for performance and security that the blockchain node operates efficiently and safely if the network is heavily loaded.

### SUMMARY OF THE INVENTION

The present disclosure has been made in an effort to provide a method and apparatus for processing blockchain messages that enables a blockchain node to efficiently and safely synchronize with other blockchain network nodes and participate in the blockchain system even under high network load conditions.

According to an exemplary embodiment, a method for processing blockchain messages in a blockchain node of a blockchain system is provided. The method for processing blockchain messages includes: receiving a transaction delivery message including at least one transaction; checking a reference block height indicating a time point in which the transaction is composed or a time point when the transaction is verified; and verifying validity of the transaction using the reference block height and a current block height.

The verifying may include: verifying the validity of the transaction and determining a validation result as a final value when the current block height is greater than a sum of the reference block height and a value of a first variable indicating the number of blocks for which determination is reserved due to a fork of the blockchain; and determining that the transaction is invalid and a validation result of the transaction as a final value, when a difference between the reference block height and a value of a second variable indicating the number of blocks for which determination is reserved due to a synchronization delay is greater than the current block height.

The verifying may further include not performing validation of the same transaction later when the validation result of the transaction is determined as the final value.

The verifying may further include verifying the validity of the transaction and determining a validation result as a temporary value, when the current block height exists within an interval between a sum of the reference block height and the first variable value and a difference between the reference block height and the second variable value.

The verifying may further include verifying the validity of the same transaction received later when the validation result of the transaction is determined as the temporary value.

The method for processing blockchain messages may further include: verifying the validity of the transaction when the reference block height does not exist; and when the transaction is verified as valid, setting a reference block height indicating a time point when the transaction is verified in any one field of a transaction delivery message including the transaction and transmitting the transaction delivery message to a neighboring node.

The reference block height indicating the time point in which the transaction is composed may be set in a configuration field of the transaction and may not be modified.

The method for processing blockchain messages may further include: transmitting the received message to one of a first input channel having a high priority and a second input channel having a low priority based on a code of the received message; processing the message of the first input channel first when there is a message in the first input channel; and processing a message in the second input channel when there is no message in the first input channel.

The receiving may include, when receiving the transaction delivery message, transmitting the transaction delivery message to the second input channel.

The transmitting the received message may include transmitting the received message to the first input channel when a message required for establishing a connection with a neighboring node is received.

The transmitting the received message may include transmitting the received message to the first input channel when a message required for receiving a block is received.

According to another embodiment, an apparatus for processing blockchain messages in a blockchain system is provided. The apparatus for processing blockchain messages includes: a read loop processor that reads messages existing on a network pipe; a message processor that transmits the messages to a first input channel having a higher priority or a second input channel having a lower priority according to a priority; and a subprotocol message processor that processes the messages of the first input channel first, and processes the messages of the second input channel when there is no message in the first input channel, when the subprotocol message processor receives a transaction delivery message including a transaction, verifies a validity of the transaction, and when a current block height is out of the range of a reservation period of a final validity determination, sets a validation result of the transaction as a final value, and does not perform validation of the transaction when the same transaction is received later.

The subprotocol message processor may determine the validation result of the transaction as a temporary value when the current block height is within the reservation period, and performs the validation of the transaction when the same transaction is received later.

The reservation period may include a range between the first value and the second value, the first value is a sum of a reference block height indicating a time point in which the transaction is composed or a time point when the transaction is verified and a value of a first variable indicating the number of blocks for which determination is reserved due to the fork of the blockchain, and the second value is a difference between the reference block height and a value of a second variable indicating the number of blocks for which determination is reserved due to the synchronization delay.

The reference block height may be set in one of the configuration fields of the transaction.

The reference block height may be set in one of the fields constituting the transaction delivery message.

The subprotocol message processor may determine that the transaction is invalid as the final value when the difference between the reference block height and the value of the second variable is greater than the current block height.

The subprotocol message processor may determine the validation result of the transaction as the final value when the current block height is greater than the sum of the reference block height and the value of the first variable.

The message processor may transmit a message to the first input channel when the message is a message required for establishing a connection with a neighboring node or a message required for receiving a block.

The message processor may transmit the transaction delivery message to the second input channel.

### BRIEF DESCRIPTION OF THE DRAWINGS

FIG. 1 is a diagram illustrating an example of a blockchain system to which an embodiment is applied.

FIG. 2 is a diagram illustrating an example of essential configuration fields of an Ethereum transaction.

FIG. 3 is a diagram illustrating an existing blockchain message processing routine.

FIG. 4 is a diagram illustrating an example of a blockchain message classified according to priority according to an embodiment.

FIG. 5 is a diagram illustrating an algorithm of a method for processing blockchain messages according to an embodiment.

FIG. 6 is a diagram illustrating an apparatus for processing block messages performing the method for processing blockchain messages shown in FIG. 5.

FIG. 7 is a flowchart illustrating a method for processing blockchain messages according to an embodiment.

FIG. 8 is a flowchart illustrating a method for verifying the transaction validity of a blockchain node according to an embodiment.

FIG. 9 is a diagram illustrating an apparatus for processing block messages according to another embodiment.

### DETAILED DESCRIPTION OF THE EMBODIMENTS

Hereinafter, embodiments of the disclosure will be described in detail with reference to the attached drawings so that a person of ordinary skill in the art may easily implement the disclosure. As those skilled in the art would realize, the described embodiments may be modified in various different ways, all without departing from the spirit or scope of the disclosure. The drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Expressions described in the singular herein may be construed as singular or plural unless an explicit expression such as “one” or “single” is used.

As used herein, “and/or” includes each and every combination of one or more of the recited elements.

In this specification, terms including an ordinal number, such as first, second, etc., may be used to describe various elements, but the elements are not limited by the terms. The above terms are used only for the purpose of distinguishing one element from another element. For example, without departing from the scope of the present disclosure, a first element may be referred to as a second element, and similarly, a second element may be referred to as a first element.

In the flowchart described with reference to the drawings in this specification, the order of operations may be changed, several operations may be merged, some operations may be divided, and specific operations may not be performed.

Furthermore, in this specification, each of the phrases such as “A or B”, “at least one of A and B”, “at least one of A or B”, “A, B, or C”, “at least one of A, B, and C”, and “at least one of A, B, or C” may include any one of the items listed together in the corresponding one of the phrases, or all possible combinations thereof.

Now, a method and apparatus for processing blockchain messages according to an embodiment of the present disclosure will be described in detail with reference to the drawings.

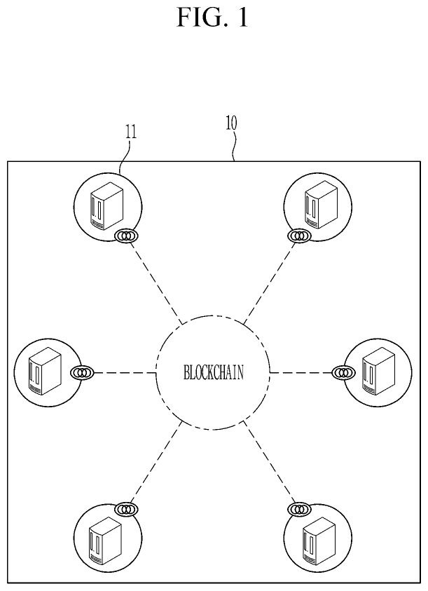

FIG. 1 is a diagram illustrating an example of a blockchain system to which an embodiment is applied.

Referring to FIG. 1, the blockchain system includes a plurality of blockchain nodes.

Transactions are propagated to the entire blockchain network so that they can be included in a block, which could be published by any node in the network. Blockchain node validates those transactions and send them to its neighboring nodes. Blockchain nodes perform the validation process to make sure that the received transactions are indeed valid and thus it is safe to deliver them to the rest of the network.

A blockchain node that stores transactions in a block stores the information of the previous block, the contents of the accumulated transactions, the hash value (or transaction identifier) of the transactions, etc. in the block, propagates the block to neighboring nodes, verifies the block, and connects it to the blockchain.

The method for processing blockchain messages according to the embodiment of the present disclosure can be applied to any blockchain system having a state. Ethereum is a representative blockchain system with a state. When a transaction is processed in the Ethereum network, the state of the related account changes. The Ethereum operates based on the state transition process in which the state changes like this.

A blockchain system with a state has a model like Equation 1.

σₜ₊₁≡ [symbol] (σₜT) (Equation 1)

The state σₜ at time t is transitioned to the state σ₍ₜ₊₁₎ by the transaction T, and [symbol] is the state transition function.

A block can contain multiple transactions. As shown in Equation 2, the state σₜ is changed to σ₍ₜ₊₁₎ as shown in Equation 3 by the block B consisting of a plurality of transactions.

B≡( . . . ,(T₀,T₁, . . . ), . . . ) (Equation 2)

σₜ₊₁≡Π(σₜ,B) (Equation 3)

Here, Π is a block unit state transition function.

The block unit state transition function performs a transaction in the order of the transactions included in the block as shown in Equation 4 to change the state, and finally, the state is changed by the block end state transition function Ω. The block end state transition function includes a function to pay a mining reward, etc.

Π(σ,B)≡Ω(B, [symbol] ( [symbol] (σ,T₀),T₁) . . . ) (Equation 4)

In this case, a function ψ that verifies the validity of the transaction T may be defined. Ψ is a function dependent on the current state a t as shown in Equation 5. That is, the validity of the transaction T may vary depending on the current state.

valid/invalid=Ψ(σₜ,T) (Equation 5)

The function ψ that verifies the validity has a binary result (valid or invalid), and since the future state σ_{(t+d)} cannot be known in advance, a transaction valid at the current time t may not be valid at a future time t+d, and a transaction valid at the current time t may be valid at the future time t+d. Therefore, even if there is a neighbor node that continues to transmit the same transaction that is determined to be invalid at a certain point in time, it is difficult to reject this transaction without verification because it is not possible to know whether the transaction will continue to be invalid, and since the blockchain node does not know the current state of the neighboring node, it cannot know whether the transaction has been verified correctly.

In order to solve this problem, the blockchain node according to the embodiment provides a method for finally performing the verification of the transaction by adding a time point at which a transaction is composed and/or a time point when the transaction is verified. Two variables are defined for this. Since a fork of a current blockchain may cause forking, and the synchronization of the current local node may be delayed to some extent, a variable fork_slack indicating the number of blocks withholding determination due to a fork and a variable delay_slack indicating the number of blocks withholding determination due to delay are defined. In case of blockchains that do not have the fork, the variable fork_slack becomes 0.

When a time point at which a transaction is composed and/or the transaction is verified is Tₕ, a validation function of the transaction T determines the validity of the transaction T as shown in Equation 6 at the current local block height I. The time point at which the transaction is verified may mean the time at which the verification of the transaction starts.

Σ(l,Tₕ,T)≡Ψ(σₗ,T),final if Tₕ+fork_slack<l,

≡invalid, final if Tₕ−delay_slack>l

≡Ψ(σₗ,T) pending otherwise (Equation 6)

First, if Tₕ (i.e., the block height at the time at which the transaction is composed or validated by a relaying node) is more than fork_slack blocks older than I (i.e., the current local block height), the recipient node of the transaction should be able to immediately determine the validity of the transaction using Equation 5 with a finality. That is, if the same transaction that has been determined to be invalid with a finality is delivered again in the future, the recipient node not only determines that the transaction is invalid, but also reasons that the sender (i.e., a neighboring node that delivered one) did not correctly validate the transaction.

Second, when Tₕ is sufficiently larger than I in which the effect of delay in synchronization is not a concern, the blockchain node may also immediately determine that the transaction is invalid with a finality. Similarly, a neighbor node that transmits this transaction can be determined to be a malicious or unhelpful neighbor to the local node. “Th-delay_slack>1” is a case in which Tₕ asserted by the node that composes or transmits a transaction is abnormally large. For example, if the current local block height I is the 10000th block and Tₕ=11000, it is an invalid assertion because it is asserting that a transaction is composed or verified at the point in time of a block that has not been clearly composed yet, and therefore the transaction is also determined as invalid.

The blockchain node validates the transaction in other cases, but the verification result is temporary and not final. Even if the corresponding transaction is invalid, it cannot be determined that the neighboring node is doing malicious or wrong actions. Therefore, when the same transaction is received later, the transaction validation process is performed again.

In the embodiment of the present disclosure, two methods are proposed for setting a time point at which a transaction is composed and/or verified in order to determine the validity of Equation 6. The first method is a method of setting the time when a transaction composes, and the second method is a method of setting the time when the transaction is verified.

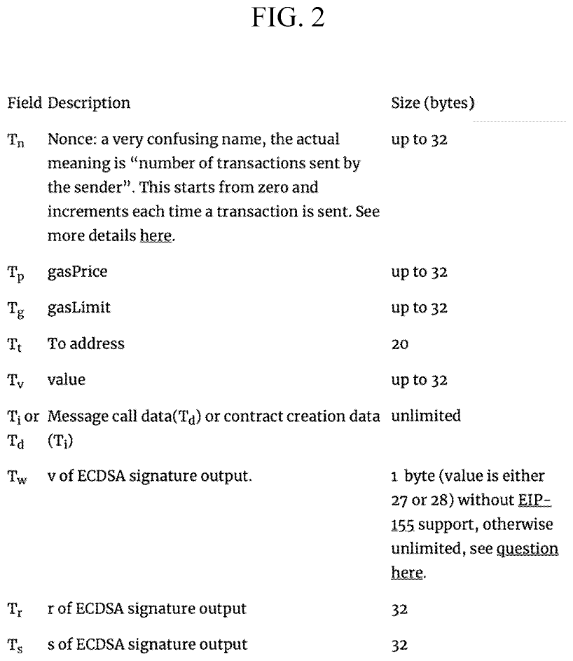

FIG. 2 is a diagram illustrating an example of essential configuration fields of an Ethereum transaction.

By setting a reference block height that indicates a time point at which a transaction is composed in an essential configuration field of a general transaction, it indicates which temporal state the transaction composed is based on.

For example, a reference block field may be added to an essential configuration field of a general transaction shown in FIG. 2, and the reference block field includes the reference block height at the time point at which the transaction is composed. The reference block height indicating when the transaction was composed is first recorded when the transaction is composed. In addition, the contents included in the transaction itself can be modified later, but the reference block height included in the transaction is not modified later. That is, the reference block height set in the transaction itself is written first by the transaction generator and is transmitted without modification thereafter.

Alternatively, the reference block height can be specified in the transaction delivery message for transaction delivery, which is a blockchain protocol message. The reference block height specified in the transaction delivery message indicates the block height at the time point of starting validation of the transaction.

In the blockchain protocol, only transactions that are determined to be valid are transmitted to the neighbor node, but when an invalid transaction is transmitted to a neighbor node, it is difficult to determine the maliciousness because it is not known in what state the validity determination was made. Therefore, the blockchain node adds a reference block field to the transaction delivery message that transmits one or more transactions, and may notify the time point at which the verification of the transaction starts by including the block height corresponding to the time point when the validation of the transaction starts in the reference block field.

In the case where the reference block height indicating the time point when the transaction composes does not exist in the configuration field of the received transaction, the blockchain node may include the reference block height indicating the time point at which the verification of the transaction starts in the transaction delivery message. In this case, validation of the transaction may be performed through Equation 5.

In this way, when the time point at which a transaction is composed and/or verified is set, the blockchain node receiving the transaction can verify the validity of the transaction based on Equation 6 using the time point at which the transaction is composed and/or verified, and in some cases, by using the validation result as the final value, the blockchain node may not perform the validation process any more when it receives the same transaction thereafter.

The validation function Σ can always finally determine the validity of the transaction except for the reservation period of the final validity determination defined by the sum of the two variables fork_slack and delay_slack. This has two effects.

First, in the case of a transaction that is determined to be invalid once with a finality, validation does not need to be performed again when the same transaction is received again from another node. Therefore, it is possible to reduce the load according to the validation. In addition, a blockchain node may receive all of one or more transactions from a neighboring node, but after receiving a hash value of the transaction first, it may request and receive one or more transactions to be received based on the hash value to the neighboring node. In this case, the blockchain node can know the validity of the transaction only by the hash value of the transaction, so it may not request or receive an actual transaction unnecessarily. In this case, the identifier of the transaction may be used instead of the hash value of the transaction.

Second, a neighbor node that repeatedly transmits a transaction that is determined to be invalid with a finality two or more times can be determined to be malicious or violating the rules, and can be disconnected or banished for a certain period of time or forever.

In general, blockchain nodes process blockchain protocol messages in the order they arrive, with no priority.

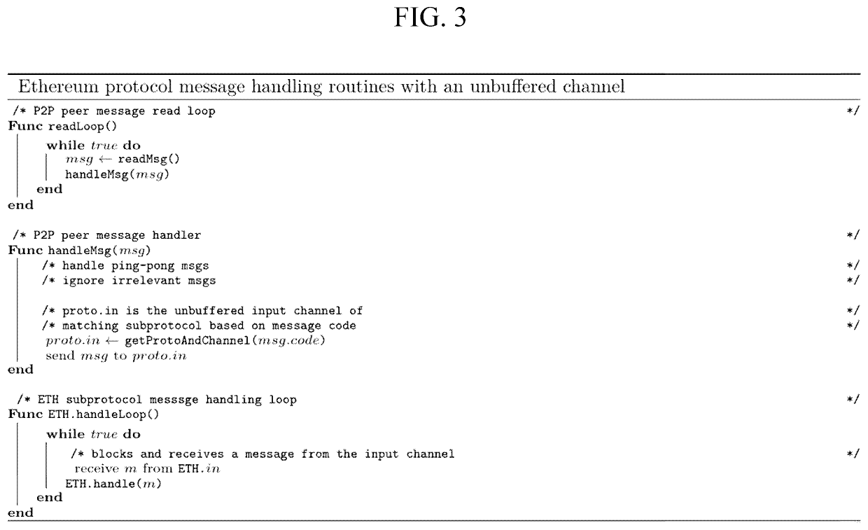

FIG. 3 is a diagram illustrating an existing blockchain message processing routine.

Referring to FIG. 3, the blockchain node receives and processes blockchain messages independently for each neighbor node. All blockchain messages are transmitted through one unbuffered channel per protocol and are processed sequentially.

The blockchain node reads a message from the unbuffered channel through a read loop readLoop, and transmits the message to the subprotocol message processing loop ETH.handleLoop that processes the message, and the subprotocol message processing loop ETH.handleLoop processes the message.

In the method using such a single channel, when a corresponding node has to process many network messages, messages may be accumulated, which may delay synchronization. In addition, an attacker may use this to perform a denial of service attack (DoS attack) or a partitioning attack.

If it is difficult for a blockchain node to process all messages received, the priority can be allocated to process necessary messages first. For this purpose, in the present disclosure, blockchain protocol messages are classified into two types according to priority.

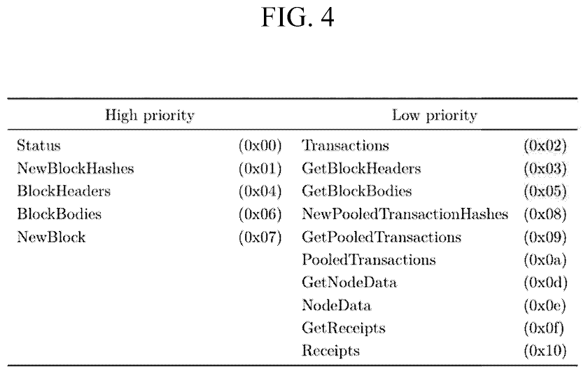

FIG. 4 is a diagram illustrating an example of a blockchain message classified according to priority according to an embodiment, and FIG. 4 shows Ethereum protocol messages classified according to priority.

Referring to FIG. 4, a message type required for establishing a connection with a neighboring node and a message type required to receive a block are classified as high priority, and the remaining messages are classified as low priority.

Messages required for establishing connection with the neighboring node should be processed first. Otherwise, a denial of service attack that prevents a new neighbor from establishing a connection is possible. Accordingly, messages required for establishing the connection with the neighbor node are allocated with a high priority.

In addition, in order to update the current state, block information must be first received. In the case of a transaction, when it is received, the blockchain node verifies the validity as shown in Equation 6, and since the result of the verification depends on the current state, if the current state is not updated to the latest, the transaction also cannot be verified correctly. Therefore, it is necessary to preferentially process block information to keep the current state up-to-date.

In FIG. 4, a status message among high priority messages is a message required to establish a connection, and the rest among high priority messages are messages required to receive a block.

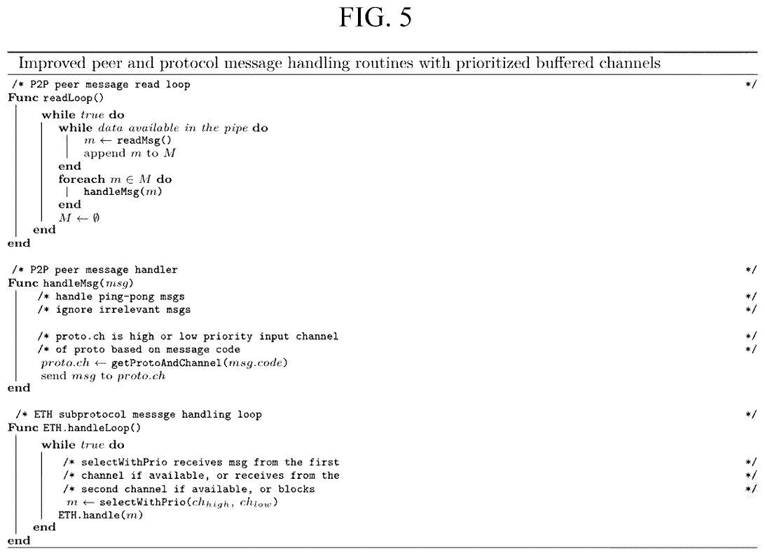

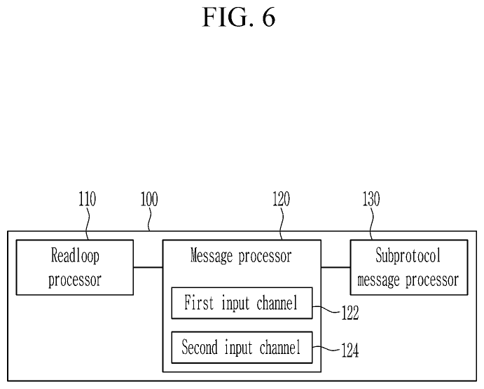

FIG. 5 is a diagram illustrating an algorithm of a method for processing blockchain messages according to an embodiment, and FIG. 6 is a diagram illustrating an apparatus for processing block messages performing the method for processing blockchain messages shown in FIG. 5.

First, referring to FIG. 6, the apparatus for processing blockchain messages 100 includes a read loop processor 110, a message processor 120, and a subprotocol message processor 130.

The read loop processor 110 executes the read loop readLoop( ) shown in FIG. 5. The read loop readLoop( ) continuously reads new messages as long as there are additional messages on the network pipe such as socket, and processes them all at once. The existence of additional data on the network pipe may not be known depending on the design or implementation of the blockchain software. In this case, the read loop readLoop( ) structure of FIG. 3 is selected to read and process messages one by one.

The message processor 120 transmits the message received from the read loop processor 110 to the first input channel or the second input channel according to the priority. A message having a high priority is transmitted to the first input channel, and a message having a low priority is transmitted to the second input channel.

In this way, unlike the existing message processing structure, the received message is transmitted to different input channels according to priority. In this case, the second input channel with low priority is implemented as a buffered channel of a fixed length capable of receiving a plurality of messages. In this case, if the second input channel is full, an attempt to additionally transmit a message to the second input channel fails. The first input channel with a high priority may be implemented as an unbuffered channel or a buffered channel, and it may be implemented in the form of waiting (blocking) or failing when the first input channel is full.

The subprotocol message processor 130 processes messages of the first input channel and the second input channel. The sub-protocol message processor 130 executes a processing loop handleLoop( ) that processes the actual protocol message. In the processing loop handleLoop( ), when there is a message in the first input channel having a high priority, the message is always read and processed. Both channels wait if there is no message.

When the message in the second input channel includes a transaction, the subprotocol message processor 130 verifies the validity of the received transaction based on Equation 6. Meanwhile, when there is no reference block height Tₕ in the message or in the configuration field of the transaction, the subprotocol message processor 130 may verify the validity of the transaction based on Equation 5.

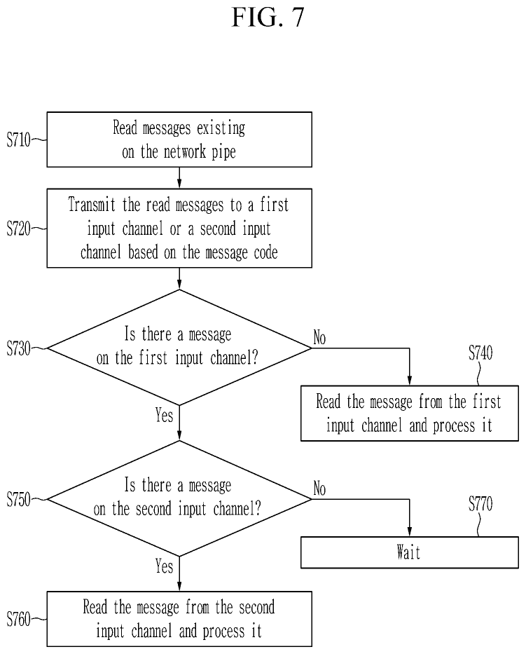

FIG. 7 is a flowchart illustrating a method for processing blockchain messages according to an embodiment.

Referring to FIG. 7, an apparatus for processing blockchain messages 100 reads messages existing on the network pipe (S710).

The apparatus for processing blockchain messages 100 transmits the read messages to a first input channel having a high priority or a second input channel having a low priority based on the message code (S720).

The apparatus for processing blockchain messages 100 checks whether a message exists in the first input channel having a high priority (S730), and when there is a message in the first input channel, first reads the message from the first input channel and processes it (S740).

On the other hand, when there is no message in the first input channel, the apparatus for processing blockchain messages 100 checks whether a message exists in the second input channel (S750).

When a message exists in the second input channel, the apparatus for processing blockchain messages 100 reads the message from the second input channel and processes it (S760).

The apparatus for processing blockchain messages 100 waits when there is no message in both the first and second input channels (S770).

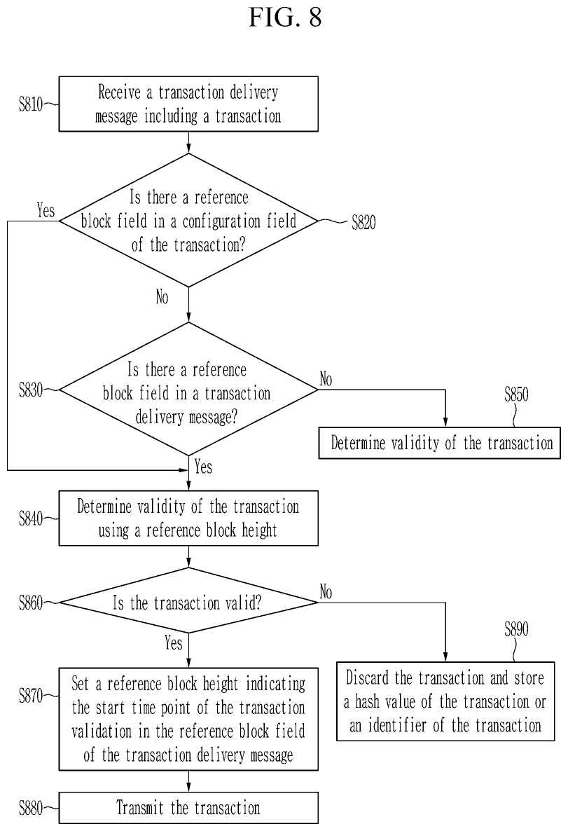

FIG. 8 is a flowchart illustrating a method for verifying the transaction validity of a blockchain node according to an embodiment.

Referring to FIG. 8, upon receiving a transaction delivery message including a transaction (S810), the blockchain node checks whether a reference block field exists in a configuration field of the transaction (S820).

When the reference block field exists in the configuration field of the transaction, the blockchain node determines validity of the transaction based on Equation 6 using a reference block height indicating the time point of generation of the transaction set in the reference block field (S840).

On the other hand, if the reference block field does not exist in the configuration field of the transaction, the blockchain node checks whether the reference block field exists in a transaction delivery message (S830).

When the reference block field exists in the transaction delivery message, the blockchain node determines the validity of the transaction based on Equation 6 using the reference block height indicating the start time point of validation of the transaction set in the reference block field (S840).

If the reference block field does not exist even in the transaction delivery message, the blockchain node determines the validity of the transaction based on Equation 5 (S850). That is, the validation result of the transaction based on Equation 5 is not final. Therefore, when the same transaction is received later, the transaction validation process is performed again.

When it is determined that the transaction is valid (S860), the blockchain node sets a reference block height indicating the start time point of the transaction validation in the reference block field of the transaction delivery message including the transaction (S870).

In this case, when the reference block height is set in the reference block field among the configuration fields of the transaction, the transaction in which the reference block height is set may be transmitted through the transaction delivery message without modification.

In addition, the blockchain node may set the reference block height indicating the start time point of the transaction validation only when the reference block height is not set in the reference block field among the configuration fields of the transaction in the reference block field in the transaction delivery message including the transaction.

The blockchain node transmits the transaction delivery message including the transaction (S880).

On the other hand, when it is determined that the transaction is finally determined to be invalid, the blockchain node discards the transaction and stores and manages a hash value of the transaction or an identifier of the transaction (S890).

By doing this, when a transaction finally determined to be invalid is received from another node later, the blockchain node may not perform a validation operation based on the hash value or identifier of an invalid transaction.

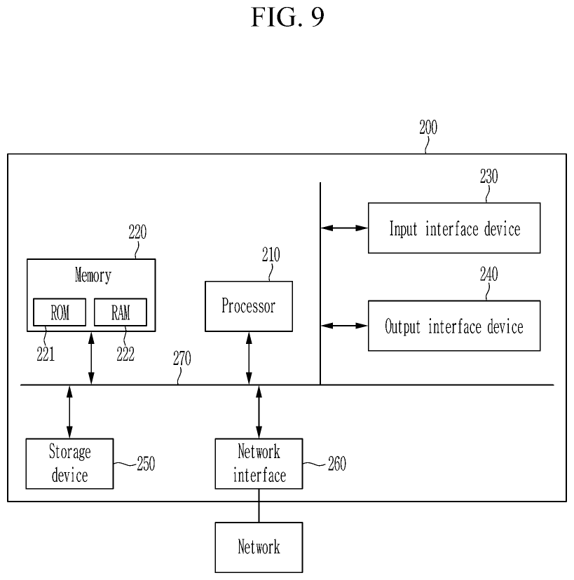

FIG. 9 is a diagram illustrating an apparatus for processing block messages according to another embodiment.

Referring to FIG. 9, an apparatus for processing block messages 200 may represent a computing device in which the aforementioned method for processing block messages is implemented.

The apparatus for processing block messages 200 may include at least one of a processor 210, a memory 220, an input interface device 230, an output interface device 240, a storage device 250, and a network interface device 260. Each of the components may be connected by a common bus 270 to communicate with each other. In addition, each of the components may be connected through an individual interface or a separate bus centering on the processor 210 instead of the common bus 270.

The processor 210 may be implemented as various types such as an application processor (AP), a central processing unit (CPU), a graphics processing unit (GPU), etc., and may be any semiconductor device that executes a command stored in the memory 220 or the storage device 250. The processor 210 may execute program commands stored in at least one of the memory 220 and the storage device 250. The processor 210 stores program commands for implementing at least some functions of the read loop processor 110, the message processor 120, and the subprotocol message processor 130 described in FIG. 6 in the memory 220, and may control to perform the operation described with reference to FIGS. 1 to 8.

The memory 220 and the storage device 250 may include various types of volatile or non-volatile storage media. For example, the memory 220 may include a read-only memory (ROM) 221 and a random access memory (RAM) 222. The memory 220 may be located inside or outside the processor 210, and the memory 220 may be connected to the processor 210 through various known means.

The input interface device 230 is configured to provide data to the processor 210.

The output interface device 240 is configured to output data from the processor 210.

The network interface apparatus 260 may transmit or receive data and signals with an external device (e.g. a neighboring node) through a wired network or a wireless network.

At least some of the method for processing block messages according to an embodiment of the present disclosure may be implemented as a program or software executed in a computing device, and the program or software may be stored in a computer-readable medium.

In addition, at least some of the method for processing block messages according to an embodiment of the present disclosure may be implemented as hardware that can be electrically connected to the computing device.

According to an embodiment, the blockchain node enables fast synchronization by preferentially processing the messages required for synchronization even under high network load conditions, and can operate safely even in denial of service (DoS) attacks or partitioning attacks.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any disclosure or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the disclosure. It will be apparent to one of ordinary skill in the art that various modifications of the embodiments may be made without departing from the spirit and scope of the claims and their equivalents.

What is claimed is:

1. A method for processing blockchain messages in a blockchain node of the blockchain system, the method comprising:
receiving a transaction delivery message including at least one transaction;
checking a reference block height indicating a time point in which the transaction is composed or a time point when the transaction is verified; and
verifying validity of the transaction using the reference block height and a current block height.

2. The method of claim 1, wherein the verifying includes:
verifying the validity of the transaction and determining a validation result as a final value when the current block height is greater than a sum of the reference block height and a value of a first variable indicating the number of blocks for which determination is reserved due to a fork of the blockchain; and
determining that the transaction is invalid and a validation result of the transaction as a final value, when a difference between the reference block height and a value of a second variable indicating the number of blocks for which determination is reserved due to a synchronization delay is greater than the current block height.

3. The method of claim 2, wherein the verifying further includes not performing validation of the same transaction later when the validation result of the transaction is determined as the final value.

4. The method of claim 2, wherein the verifying further includes verifying the validity of the transaction and determining a validation result as a temporary value, when the current block height exists within an interval between a sum of the reference block height and the first variable value and a difference between the reference block height and the second variable value.

5. The method of claim 4, wherein the verifying further includes verifying the validity of the same transaction received later when the validation result of the transaction is determined as the temporary value.

6. The method of claim 1, further comprising:
verifying the validity of the transaction when the reference block height does not exist; and
when the transaction is verified as valid, setting a reference block height indicating a time point when the transaction is verified in any one field of a transaction delivery message including the transaction and transmitting the transaction delivery message to a neighboring node.

7. The method of claim 1, wherein the reference block height indicating the time point in which the transaction is composed is set in a configuration field of the transaction and is not modified.

8. The method of claim 1, further comprising:
transmitting the received message to one of a first input channel having a high priority and a second input channel having a low priority based on a code of the received message;
processing the message of the first input channel first when there is a message in the first input channel; and
processing a message in the second input channel when there is no message in the first input channel.

9. The method of claim 8, wherein the receiving includes, when receiving the transaction delivery message, transmitting the transaction delivery message to the second input channel.

10. The method of claim 8, wherein the transmitting the received message includes transmitting the received message to the first input channel when a message required for establishing a connection with a neighboring node is received.

11. The method of claim 8, wherein the transmitting the received message includes transmitting the received message to the first input channel when a message required for receiving a block is received.

12. An apparatus for processing blockchain messages in a blockchain system, the apparatus comprising:
a read loop processor that reads messages existing on a network pipe;
a message processor that transmits the messages to a first input channel having a higher priority or a second input channel having a lower priority according to a priority; and
a subprotocol message processor that processes the messages of the first input channel first, and processes the messages of the second input channel when there is no message in the first input channel,
wherein when the subprotocol message processor receives a transaction delivery message including a transaction, it verifies validity of the transaction, and when a current block height is out of the range of a reservation period of a final validity determination, sets a validation result of the transaction as a final value, and does not perform validation of the transaction when the same transaction is received later.

13. The apparatus of claim 12, wherein the subprotocol message processor determines the validation result of the transaction as a temporary value when the current block height is within the reservation period, and performs the validation of the transaction when the same transaction is received later.

14. The apparatus of claim 12, wherein the reservation period includes a range between the first value and the second value,
the first value is a sum of a reference block height indicating a time point in which the transaction is composed or a time point when the transaction is verified and a value of a first variable indicating the number of blocks for which determination is reserved due to the fork of the blockchain, and
the second value is a difference between the reference block height and a value of a second variable indicating the number of blocks for which determination is reserved due to a synchronization delay.

15. The apparatus of claim 14, wherein the reference block height is set in one of the configuration fields of the transaction.

16. The apparatus of claim 14, wherein the reference block height is set in one of the fields constituting the transaction delivery message.

17. The apparatus of claim 14, wherein the subprotocol message processor determines that the transaction is invalid as the final value when the difference between the reference block height and the value of the second variable is greater than the current block height.

18. The apparatus of claim 14, wherein the subprotocol message processor determines the validation result of the transaction as the final value when the current block height is greater than the sum of the reference block height and the value of the first variable.

19. The apparatus of claim 12, wherein the message processor transmits a message to the first input channel when the message is a message required for establishing a connection with a neighboring node or a message required for receiving a block.

20. The apparatus of claim 12, wherein the message processor transmits the transaction delivery message to the second input channel.
